(19) United States
(12) Patent Application Publication
(10) Pub. No.: US 2018/0307418 A1
(43) Pub. Date: Oct. 25, 2018

(54) DYNAMIC BACKGROUND COPY AGENT ALLOCATION

(71) Applicant: International Business Machines Corporation, Armonk, NY (US)

(72) Inventors: Theresa M. Brown, Tucson, AZ (US); Gang Lyu, Shanghai (CN)

(73) Assignee: International Business Machines Corporation, Armonk, NY (US)

(21) Appl. No.: 15/494,510

(22) Filed: Apr. 23, 2017

(51) Int. Cl. G06F 3/06

(52) U.S. Cl. CPC G06F 3/0613; G06F 3/067; G06F 3/0619; G06F 3/065

(57) ABSTRACT

A method for dynamically allocating copy agents to a background copy process is disclosed. In one embodiment, such a method includes monitoring current host throughput to a source array. The method initiates a background copy process to copy data from the source array to a target array. This includes allocating agents to copy data from the source array to the target array. While the background copy process is executing, the method monitors background copy throughput to the source array and dynamically adjusts the number of agents allocated to the background copy process in accordance with changes to the host throughput. A corresponding system and computer program product are also disclosed.

### BACKGROUND

### Field of the Invention

This invention relates to systems and methods for copying data from a source volume to a target volume.

### Background of the Invention

Data replication functions such as IBM's FlashCopy® may be used to generate nearly instantaneous point-in-time copies of logical volumes or data sets. Among other uses, these point-in-time copies may be used for disaster recovery and business continuity purposes. IBM's FlashCopy® in particular creates a point-in-time copy by establishing a mapping relationship between a source volume and a target volume. Once this mapping relationship is established, data may be read from either the source volume or target volume even before all data in the source volume has been copied to the target volume. In certain cases, a background copy process may be enabled to copy data from the source volume to the target volume. A target bit map associated with the target volume may keep track of which data tracks have actually been copied from the source volume to the target volume.

When initiating a background copy process, a fixed number of copy agents may be allocated to copy data from the source volume to the target volume. Because of the fixed number, the I/O workload on the source volume and target volume resulting from the background copy process may stay fairly consistent regardless of the level of external (e.g., host) I/O thereto. To minimize the impact on host I/O, the workload of the background copy process is typically low. Unfortunately, this means that the background copy process typically takes a significant amount of time to complete. This prolongs the amount of time needed to achieve an independent target volume.

In view of the foregoing, what are needed are systems and methods to more efficiently copy data from a source volume to a target volume. Ideally, such systems and methods will reduce the amount of time needed for a background copy process to complete, while not significantly degrading host I/O performance.

### SUMMARY

The invention has been developed in response to the present state of the art and, in particular, in response to the problems and needs in the art that have not yet been fully solved by currently available systems and methods. Accordingly, systems and methods are disclosed to dynamically allocate copy agents to a background copy process. The features and advantages of the invention will become more fully apparent from the following description and appended claims, or may be learned by practice of the invention as set forth hereinafter.

Consistent with the foregoing, a method for dynamically allocating copy agents to a background copy process is disclosed. In one embodiment, such a method includes monitoring current host throughput to a source array. The method initiates a background copy process to copy data from the source array to a target array. This includes allocating agents to copy data from the source array to the target array. While the background copy process is executing, the method monitors background copy throughput to the source array. The method further determines a maximum throughput of the source array to maintain normal host I/O response times. The method repeatedly performs the following to dynamically adjust the number of agents allocated to the background copy process: determine a current throughput to the source array by summing the host throughput and the current background copy throughput; allocate an additional agent to the background copy process if the additional agent can be allocated without causing the current throughput to exceed the maximum throughput; and remove an agent from the background copy process if the current throughput exceeds the maximum throughput.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment in which a system and method in accordance with the invention may be implemented;

FIG. 2 is a high-level block diagram showing one example of a storage system in which a system and method in accordance with the invention may be implemented;

FIG. 3 is a high-level block diagram showing various components that play a role in executing a background copy process;

FIG. 4 is a process flow diagram showing a method for allocating copy agents to a background copy process when a point-in-time-copy relation is established;

FIG. 5 is a process flow diagram showing a method for dynamically increasing copy agents allocated to a background copy process; and

FIG. 6 is a process flow diagram showing a method for dynamically reducing copy agents allocated to a background copy process.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

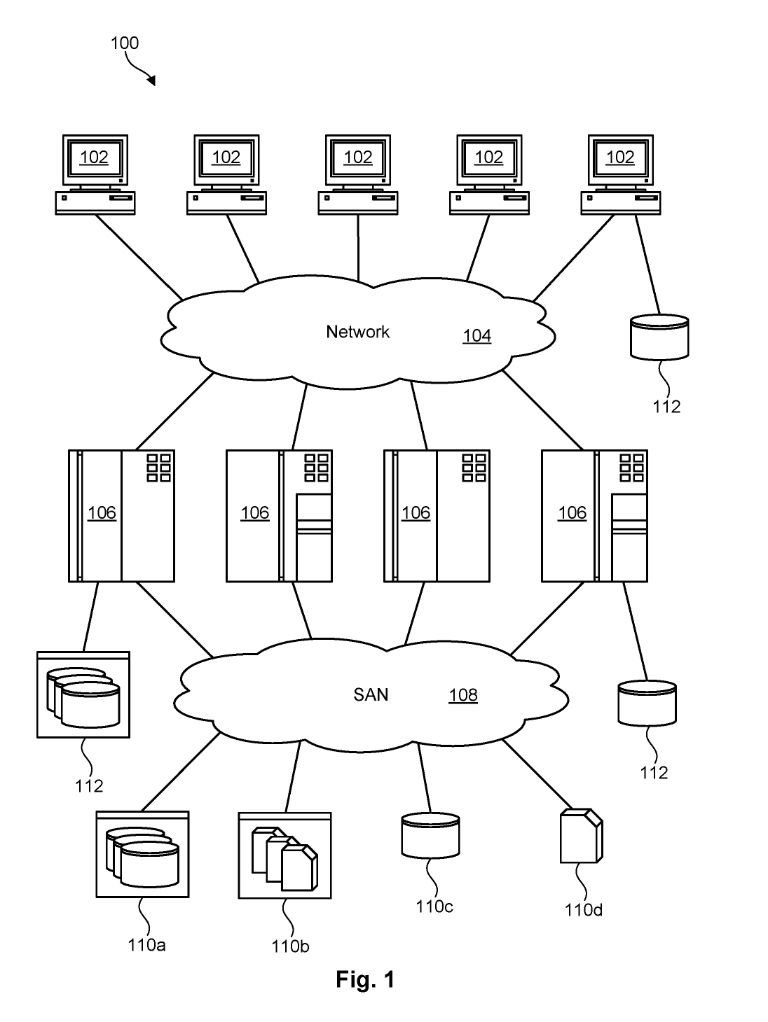

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays of hard-disk drives or solid-state drives, tape libraries, individual hard-disk drives or solid-state drives, tape drives, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC). One or more of the storage systems 110 may utilize the systems and methods disclosed herein.

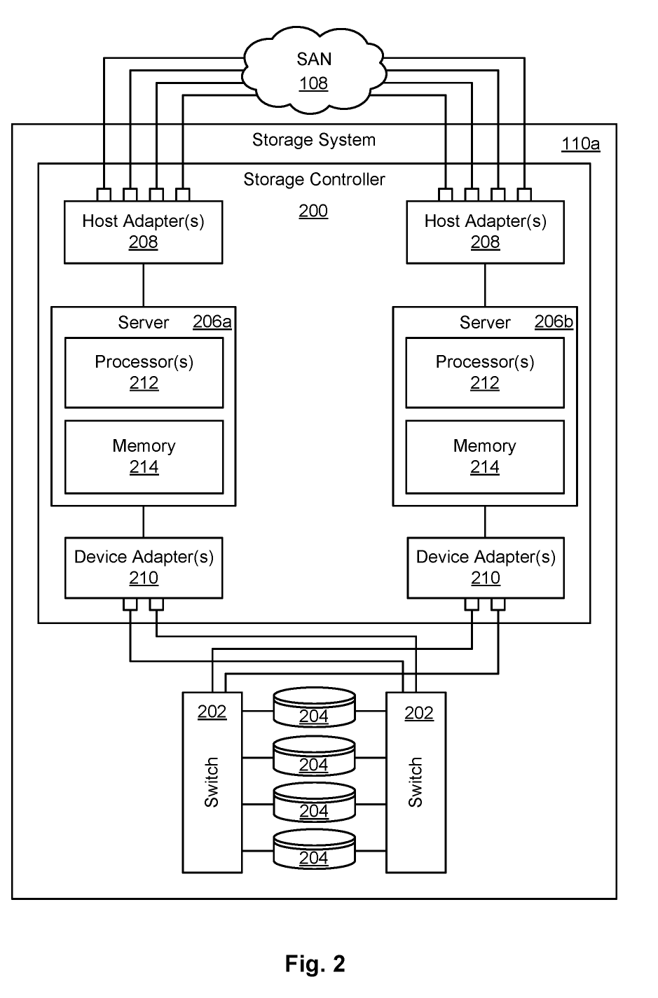

Referring to FIG. 2, one embodiment of a storage system 110 containing an array of hard-disk drives 204 and/or solid-state drives 204 is illustrated. The internal components of the storage system 110 are shown since such a storage system 110 may implement the systems and methods disclosed herein. As shown, the storage system 110 includes a storage controller 200, one or more switches 202, and one or more storage devices 204, such as hard disk drives 204 or solid-state drives 204 (such as flash-memory-based drives 204). The storage controller 200 may enable one or more hosts 106 (e.g., open system and/or mainframe servers 106) to access data in the one or more storage devices 204.

In selected embodiments, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage devices 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage devices 204. These software modules may manage all read and write requests to logical volumes in the storage devices 204.

One example of a storage system 110 having an architecture similar to that illustrated in FIG. 2 is the IBM DS8000™ enterprise storage system. The DS8000™ is a high-performance, high-capacity storage controller providing disk storage that is designed to support continuous operations. Nevertheless, the systems and methods disclosed herein are not limited to the IBM DS8000™ enterprise storage system 110, but may be implemented in any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented only by way of example and is not intended to be limiting.

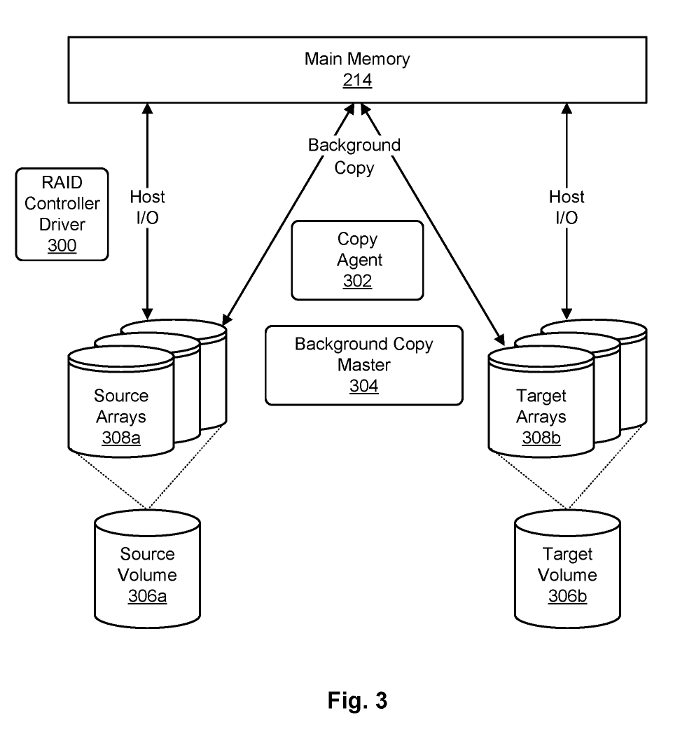

Referring to FIG. 3, as previously mentioned, data replication functions such as IBM's FlashCopy® may be used to generate nearly instantaneous point-in-time copies of logical volumes or data sets. Among other uses, these point-in-time copies may be used for disaster recovery and business continuity purposes. IBM's FlashCopy®, for example, may be used to create a point-in-time copy by establishing a mapping relationship between a source volume 306a and a target volume 306b. Once this mapping relationship is established, data may be read from either the source volume 306a or target volume 306b even before all data in the source volume 306a has been copied to the target volume 306b. In certain cases, a background copy process may be enabled to copy data from the source volume 306a to the target volume 306b. A target bit map associated with the target volume 306b may keep track of which data tracks have actually been copied from the source volume 306a to the target volume 306b.

When initiating a conventional background copy process, a fixed number of copy agents may be allocated to copy data from the source volume 306a to the target volume 306b. Because of the fixed number, the I/O workload on the source volume 306a and target volume 306b resulting from the background copy process stays fairly consistent regardless of the level of external (e.g., host) I/O thereto. To minimize the impact on host I/O, the workload of the background copy process is typically low. Unfortunately, this means that the background copy process typically takes a significant amount of time to complete. This prolongs the amount of time needed to achieve an independent target volume 306b.

In order to increase (or even maximize) the speed of the background copy process without negatively impacting host I/O to the source volume 306a and/or target volume 306b, systems and methods in accordance with the invention may dynamically allocate background copy agents to the background copy process on the fly in accordance with the host I/O workload. More specifically, systems and methods in accordance with the invention may decrease the number of copy agents as the host I/O workload increases, and increase the number of copy agents as the host I/O workload decreases. In certain embodiments, systems and methods in accordance with the invention may utilize excess bandwidth of backend storage arrays (i.e., bandwidth not used to process host I/O workload) to execute the background copy process. This will ensure that the background copy process completes as soon as possible without impacting host I/O performance.

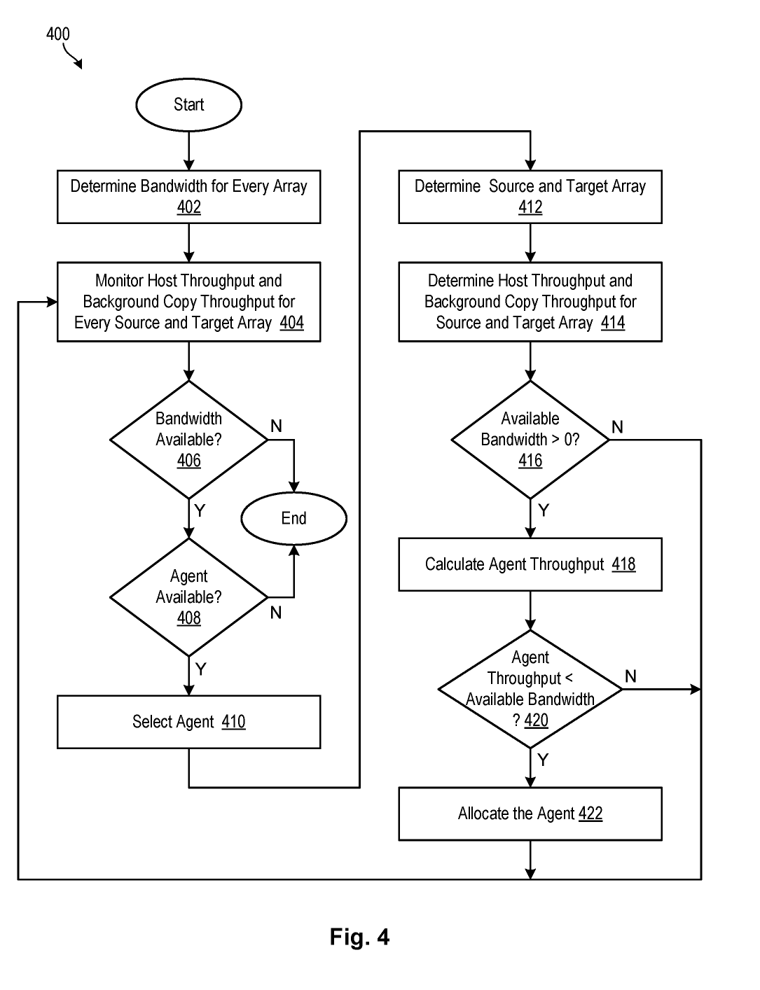

FIG. 3 shows various components that are involved in executing a background copy process. As shown, a background copy master 304 controls allocation of copy agents 302 in accordance with various algorithms. These algorithms will be discussed in association with FIGS. 4 through 6. The background copy master 304 may monitor progress of the background copy process and communicate with a RAID (redundant array of independent disks) controller driver 300 to acquire performance data, the likes of which will be discussed in more detail hereafter. The RAID controller driver 300 may, in certain embodiments, be embodied in the device adapters 210 previously described. The RAID controller driver 300 controls staging of data from source arrays 308a to main memory 214, and destaging of data from the main memory 214 to target arrays 308b. The source arrays 308a are the RAID arrays containing tracks of the source volume 306a in a point-in-time copy relationship. The target arrays 308b are the RAID arrays containing tracks of the target volume 306b in the point-in-time copy relationship.

FIG. 4 shows one embodiment of a method 400 for allocating copy agents 302 to a background copy process when a point-in-time-copy relationship is established. Such a method 400 may, in certain embodiments, be executed by the background copy master 304 previously described. As shown, the method 400 initially determines 402 the maximum throughput that the source arrays 308a and target arrays 308b can handle while still providing normal I/O response times. This may depend on the type and performance of storage drives 204 (e.g., hard disk drives) in the arrays 308a, 308b, the number of storage drives 204 in the arrays 308a, 308b, the RAID type or level, and/or the like. The maximum throughput is normally a fixed value when the arrays 308a, 308b are configured. This maximum throughput may be set slightly less than the actual throughput that can be handled by the arrays 308a, 308b to provide some buffer of protection against workload bursts.

The method 400 (and more specifically the RAID controller driver 300) continuously monitors 404 the host throughput and background-copy-process throughput for every source and target array 308a, 308b. The method 400 then determines 406 whether any of the source arrays 308a or target arrays 308b have available bandwidth that can be allocated to the background copy process. If not, the method 400 ends. If bandwidth is available at step 406, however, the method 400 determines 408 whether any copy agents 302 are available to be allocated to the background copy process. If not, the method 400 ends.

If, at step 408, at least one copy agent 302 is available, the method 400 selects 410 a copy agent 302. The copy agent 302 may be selected based on various algorithms, such as priority algorithms, first-in-first-out algorithms, round robin algorithms, etc. The method 400 then determines 412 the source array 308a and target array 308b that the copy agent 302 will copy data between, and determines 414 the current host throughput and background-copy-process throughput for the source and target arrays 308a, 308b. If, at step 416, the available bandwidth (i.e., maximum throughput minus the host throughput and background-copy-process throughput) for both the source array 308a and target array 308b is greater than zero, the method 400 calculates 418 the throughput associated with the copy agent 302 that was selected at step 410.

If the throughput associated with the selected copy agent 302 is not known, the throughput may be calculated by retrieving, from the RAID controller driver 300, an average transfer time for the copy agent 302 to read a block of data from the source volume 306a and write it to the target volume 306b. The transfer time may be the sum of the time needed for the copy agent 302 to locate a block to read in a bitmap, generate a stage command and send it to the source volume 306a, stage the block of data from the source volume 306a to the cache 214 (i.e., main memory 214), and destage the data from the cache 214 to the target volume 306b.

The transfer time discussed above varies primarily in accordance with the stage time and destage time, which is affected by the type of storage drives 204 in the arrays 308a, 308b and the workload being serviced by the arrays 308a, 308b. For example, solid state storage drives 204 will typically have a lower transfer time than hard disk storage drives 204, and arrays 308a, 308b experiencing a lower workload will typically have a lower transfer time than arrays 308a, 308b experiencing a higher workload, all other things being equal. If the transfer time cannot be acquired from the RAID controller driver 300, the method 400 may calculate the transfer time by reading a data block with a specified granularity from the source array 308a, writing the data block to the target array 308b, and recording the amount of time needed to do so. The specified granularity may be the size of data transferred by a copy agent 302 from the source volume 306a to the target volume 306b in a single try. Once the transfer time is calculated, the throughput of the copy agent 302 may be calculated by dividing the specified granularity by the transfer time.

Once the throughput of the selected copy agent 302 is calculated at step 418, the method 400 determines 420 whether the throughput of the selected copy agent 302 is less than the available bandwidth (which is equal to the maximum throughput minus the host throughput and the background-copy-process throughput). In essence, this step 420 determines if adding the copy agent 302 to the background copy process will cause the maximum throughput of the source array 308a and/or target array 308b to be exceeded. If the maximum throughput will not be exceeded, the method 400 allocates 422 the selected copy agent 302. Allocating this copy agent 302 will dedicate more resources to the background copy process without substantially impacting host throughput. The method 400 repeats this process and adds more copy agents 302 to the background copy process if doing do will not cause the maximum throughput of the source arrays 308a and/or target arrays 308b to be exceeded.

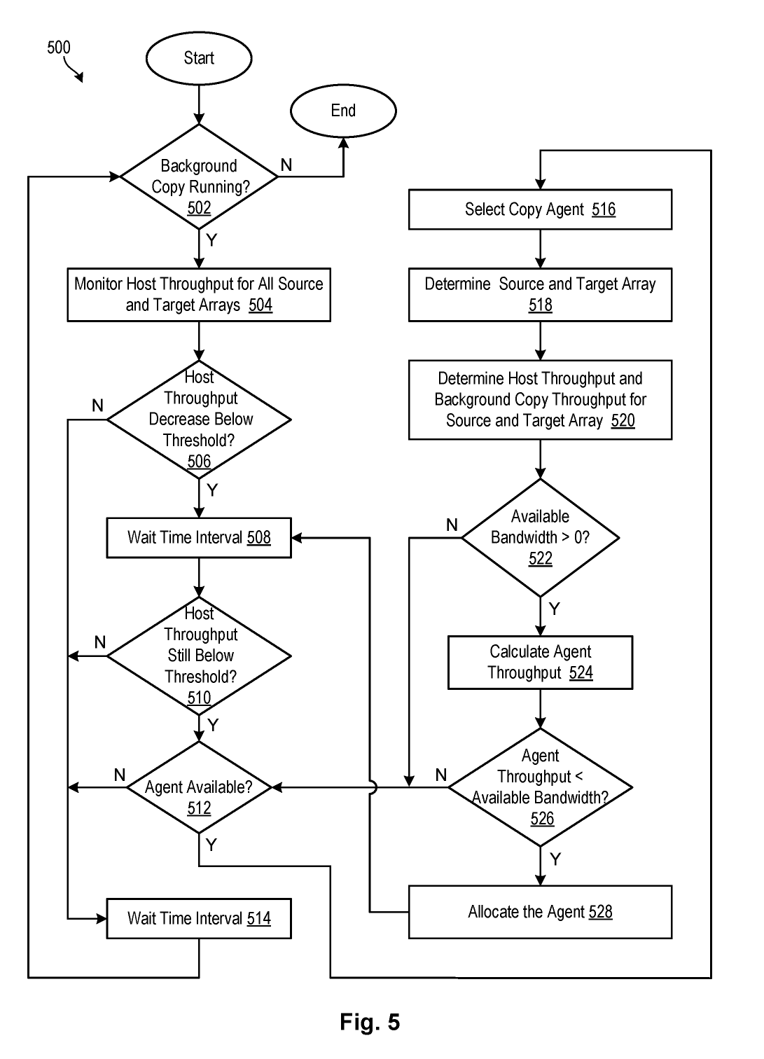

FIG. 5 shows a method 500 for dynamically increasing copy agents 302 allocated to a background copy process. Such a method 500 may, in certain embodiments, be executed by the background copy master 304 previously described. As shown, the method 500 initially determines 502 whether a background copy process is running for a source volume 306a and target volume 306b. If so, the method 500 monitors 504 host throughput for all source and target arrays 308a, 308b associated with the source volume 306a and target volume 306b. If, at step 506, the host throughput drops by a threshold amount while the background copy process is running, the method 500 waits 508 a pre-determined time interval and then checks 510 again whether the host throughput is still below the threshold. Waiting 508 the pre-determined time interval assures that the decrease in the host throughput is not a just a temporary decrease and also ensures that the number of copy agents 302 allocated to the background copy process does not change too rapidly.

If, at step 510, the host throughput is still below the threshold, the method 500 determines 512 whether at least one copy agent 302 is available to allocate to the background copy process. If so, the method 500 selects 516 a copy agent 302 and determines 518 the source and target arrays 308a, 308b that the copy agent 302 will copy data between. The method 500 further determines 520 the host throughput and background-copy-process throughput (e.g., by querying the RAID controller driver 300 which may periodically record these values) for the source and target arrays 308a, 308b and determines 522 whether additional bandwidth is available for each of the source and target arrays 308a, 308b. This may be accomplished by subtracting the host throughput and background-copy-process throughput from the maximum throughput associated with the source and target arrays 308a, 308b. If bandwidth is available for both the source and target arrays 308a, 308b, the method 500 calculates 524 the copy agent 302 throughput. This may be accomplished in the same manner described above in association with step 418 of FIG. 4.

If, at step 526, the copy agent 302 throughput is less than the available bandwidth for both the source and target arrays 308a, 308b, the method 500 allocates 528 the copy agent 302 to the background copy process. If, on the other hand, the copy agent 302 throughput is not less than the available bandwidth for both the source and target arrays 308a, 308b, the method 500 checks 512 whether another copy agent 302 is available and, if so, proceeds through steps 516, 518, 520, 522, 524, 526, 528 to determine whether to allocate the copy agent 302. After allocating a copy agent 302 at step 528, the method 500 waits 508 the time interval previous discussed and proceeds through the process again to determine if another copy agent 302 can be allocated. This process repeats until copy agents 302 are allocated to consume all available bandwidth (or until all copy agents 302 are utilized) while ensuring that the maximum throughput is not exceeded for the source and target arrays 308a, 308b.

If, at step 506, the host throughput has not decreased by a threshold amount, the method 500 waits 514 a pre-determined time interval and the method 500 begins again from the top. If at any time the method 500 determines 502 that the background copy process is no longer running, the method 500 ends.

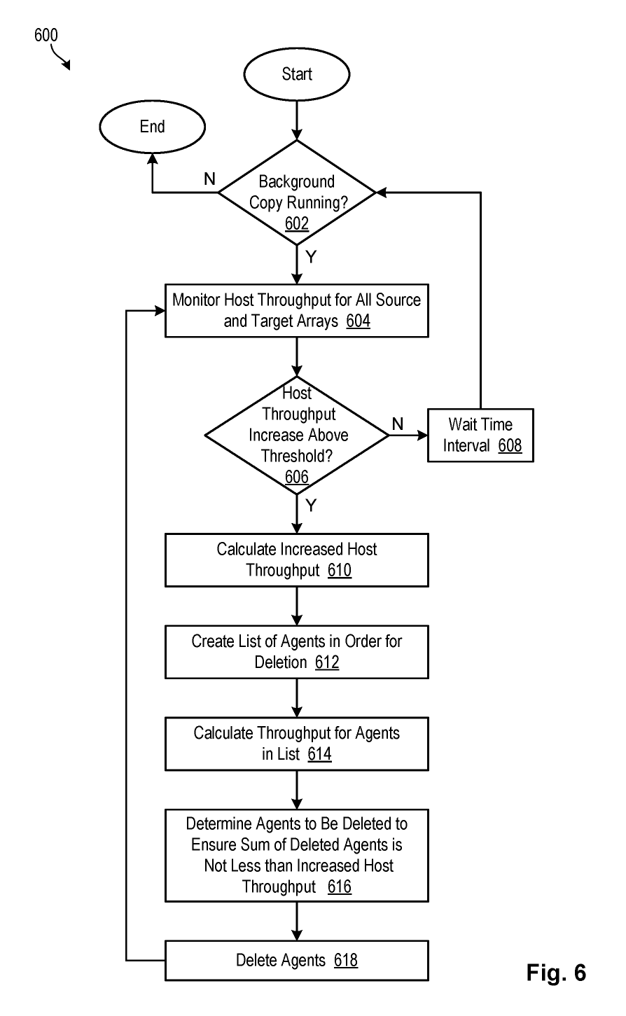

FIG. 6 shows a method 600 for dynamically reducing a number of copy agents 302 allocated to a background copy process. Such a method 600 may, in certain embodiments, be executed by the background copy master 304 previously described. As shown, the method 600 initially determines 602 whether a background copy process is running for a source volume 306a and target volume 306b. If so, the method 600 monitors 604 host throughput for all source and target arrays 308a, 308b associated with the source volume 306a and target volume 306b. If, at step 606, the host throughput rises by a threshold amount for either the source arrays 308a or target arrays 308b while the background copy process is running, the method 600 calculates 610 the increased host throughput.

The method 600 then creates 612 a list of copy agents 302 that are currently allocated to the background copy process in order for deletion. The method 600 calculates 614 the throughput for each of the copy agents 302 in the list. This may be accomplished by acquiring, from the RAID controller driver 300, the transfer time for each of the copy agents 302 in the list, or by observing actual transfer times for copy agents 302 that are transferring data between the source arrays 308a and target arrays 308b. The throughput for each copy agent 302 may be calculated 614 by dividing the data block size that is being transferred by the transfer time.

The method 600 then determines 616 which copy agents 302 are to be deleted. In doing so, the method 600 ensures that the sum of the throughputs for the copy agents 302 that are to be deleted is not less than the increase in the host throughput. At the same time, the method 600 does not delete more copy agents 302 than are needed to compensate for the increased host throughput. Once the copy agents 302 to be deleted are determined 616, the method 600 deletes 618 the copy agents 302. If multiple arrays 308a, 308b encounter I/O workloads beyond their bandwidth, the method 600 may choose to first delete copy agents 302 that have source and target arrays 308a, 308b that are both overdriven.

If, at step 606, the host throughput has not increased by a threshold amount, the method 600 waits 608 a pre-determined time interval and the method 600 begins again from the beginning. If, at any time, the method 600 determines 602 that the background copy process is no longer running, the method 600 ends.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for dynamically allocating agents to a background copy process, the method comprising:
monitoring current host throughput to a source array;
initiating a background copy process to copy data from the source array to a target array, wherein initiating the background copy process comprises allocating agents to copy data from the source array to the target array;
monitoring current background copy throughput to the source array as a result of the background copy process;
determining a maximum throughput of the source array to maintain normal host I/O response times; and
repeatedly performing the following:
determine a current throughput to the source array by summing the host throughput and the current background copy throughput;
allocate an additional agent to the background copy process if the additional agent can be allocated without causing the current throughput to exceed the maximum throughput; and
remove an agent from the background copy process if the current throughput exceeds the maximum throughput.

2. The method of claim 1, further comprising, prior to allocating the additional agent to the background copy process, determining if the additional agent can be allocated without causing the current throughput to exceed the maximum throughput.

3. The method of claim 2, wherein determining if the additional agent can be allocated without causing the current throughput to exceed the maximum throughput comprises determining how much additional throughput the additional agent will impose on the source array.

4. The method of claim 3, where determining how much additional throughput the additional agent will impose on the source array comprises recording an amount of time required for the additional agent to transfer a block of data from the source array to the target array and extrapolating the additional throughput from this amount of time.

5. The method of claim 3, wherein allocating the additional agent comprises allocating the additional agent if the sum of the current throughput and the additional throughput will not exceed the maximum throughput.

6. The method of claim 1, wherein the current host throughput fluctuates over time.

7. The method of claim 1, wherein monitoring the current host throughput to the source array comprises continuously monitoring the current host throughput to the source array.

8. A computer program product for dynamically allocating agents to a background copy process, the computer program product comprising a computer-readable storage medium having computer-usable program code embodied therein, the computer-usable program code configured to perform the following when executed by at least one processor:
monitor current host throughput to a source array;
initiate a background copy process to copy data from the source array to a target array, wherein initiating the background copy process comprises allocating agents to copy data from the source array to the target array;
monitor current background copy throughput to the source array as a result of the background copy process;
determine a maximum throughput of the source array to maintain normal host I/O response times; and
repeatedly perform the following:
determine a current throughput to the source array by summing the host throughput and the current background copy throughput;
allocate an additional agent to the background copy process if the additional agent can be allocated without causing the current throughput to exceed the maximum throughput; and
remove an agent from the background copy process if the current throughput exceeds the maximum throughput.

9. The computer program product of claim 8, wherein the computer-usable program code is further configured to, prior to allocating the additional agent to the background copy process, determine if the additional agent can be allocated without causing the current throughput to exceed the maximum throughput.

10. The computer program product of claim 9, wherein determining if the additional agent can be allocated without causing the current throughput to exceed the maximum throughput comprises determining how much additional throughput the additional agent will impose on the source array.

11. The computer program product of claim 10, where determining how much additional throughput the additional agent will impose on the source array comprises recording an amount of time required for the additional agent to transfer a block of data from the source array to the target array and extrapolating the additional throughput from this amount of time.

12. The computer program product of claim 10, wherein allocating the additional agent comprises allocating the additional agent if the sum of the current throughput and the additional throughput will not exceed the maximum throughput.

13. The computer program product of claim 8, wherein the current host throughput fluctuates over time.

14. The computer program product of claim 8, wherein monitoring the current host throughput to the source array comprises continuously monitoring the current host throughput to the source array.

15. A system for dynamically allocating agents to a background copy process, the system comprising:
at least one processor;
at least one memory device operably coupled to the at least one processor and storing instructions for execution on the at least one processor, the instructions causing the at least one processor to:
monitor current host throughput to a source array;
initiate a background copy process to copy data from the source array to a target array, wherein initiating the background copy process comprises allocating agents to copy data from the source array to the target array;
monitor current background copy throughput to the source array as a result of the background copy process;
determine a maximum throughput of the source array to maintain normal host I/O response times; and
repeatedly perform the following:
determine a current throughput to the source array by summing the host throughput and the current background copy throughput;
allocate an additional agent to the background copy process if the additional agent can be allocated without causing the current throughput to exceed the maximum throughput; and
remove an agent from the background copy process if the current throughput exceeds the maximum throughput.

16. The system of claim 15, wherein the instructions further cause the at least one processor to, prior to allocating the additional agent to the background copy process, determine if the additional agent can be allocated without causing the current throughput to exceed the maximum throughput.

17. The system of claim 16, wherein determining if the additional agent can be allocated without causing the current throughput to exceed the maximum throughput comprises determining how much additional throughput the additional agent will impose on the source array.

18. The system of claim 17, where determining how much additional throughput the additional agent will impose on the source array comprises recording an amount of time required for the additional agent to transfer a block of data from the source array to the target array and extrapolating the additional throughput from this amount of time.

19. The system of claim 17, wherein allocating the additional agent comprises allocating the additional agent if the sum of the current throughput and the additional throughput will not exceed the maximum throughput.

20. The system of claim 15, wherein monitoring the current host throughput to the source array comprises continuously monitoring the current host throughput to the source array.
